(19) United States
(12) Patent Application Publication
(10) Pub. No.: US 2013/0266927 A1
(43) Pub. Date: Oct. 10, 2013

(54) Immersive Video Game Features

(71) Applicant: ROCKET SURGEON ENTERTAINMENT, INC., Plymounth, MN (US)

(72) Inventor: Shei Mann, Plymouth, MN (US)

(21) Appl. No.: 13/860,506

(22) Filed: Apr. 10, 2013

Related U.S. Application Data
(60) Provisional application No. 61/622,502, filed on Apr. 10, 2012.

(51) Int. Cl. A63F 13/00

(52) U.S. Cl. CPC A63F 13/00
USPC 434/362

(57) ABSTRACT

A computer-implemented electronic gaming method for electronic polling includes receiving a third-party request to provide a polling question, for a fee, to members of an electronic on-line gaming community; submitting the polling question to a plurality of members of the on-line gaming community and obtaining responses from at least some of the plurality of members; identifying demographic information for the plurality of members in order to select the plurality of members to be subjected to the polling question, to characterize responses from the plurality of members, or both; and providing, to the third-party that requested provision of the polling question, statistical information about the obtained responses, the statistical information not identifying any personally identifiable information about particular ones of the members.

### CLAIM OF PRIORITY

This application claims priority under 35 USC §119(e) to U.S. Provisional Patent Application Ser. No. 61/622,502, filed on Apr. 10, 2012, the entire contents of which are hereby incorporated by reference.

### TECHNICAL FIELD

This document relates to systems and techniques for presenting multiple-player role-playing video games and related features.

### BACKGROUND

Massively multi-player on-line role playing games (MMPORGs) are great entertainment and big business. Games like World of Warcraft provide hours of entertainment and socialization for players, while immersive worlds like Second Life allow players to take on roles and pursue interests that they might not be comfortable pursuing in real life. Such worlds have great benefits for their participants, but can also financially benefit their operators and others (e.g., advertisers or makers of virtual goods and services) who interact with the worlds.

### SUMMARY

This document describes systems and techniques that may be used as part of an MMPORG that is tied to real-world current events, and that therefore can be kept fresh by adding aspects of those real-world events into the game. In one particular manner, the game may revolve around the topic of politics, and players in the game may take on political roles, such as playing the roles of politicians and staffers for those politicians. As one example, each player can take on the role of a recently-elected 436th member of the U.S. House of Representatives (or 101st Senator), and may make decisions within the game that such a politician would make in order to please constitutes, perform good work, raise money, and get re-elected, among other things. The other politicians may be avatars for other players (e.g., friends of the first player) where the avatars act according to the wishes of the other players, or may be virtual representations of the real-world politicians who they represent and may act in the game according to models that represent how those politicians are expected to act in the real world when faced with similar situations (e.g., how they would likely vote on a particular issue).

A player may make his or her position on issues known via floor and committee debate, communications (e.g., mailings) to constituents, and interviews with friendly or hostile media outlets. To simplify play and to make it easier to determine a player's position on a nuanced issue, a player may be provided with “cards” that the player may employ for their avatar in appropriate situations. For example, when faced with an opportunity to state a position on an issue related to oil drilling, the player may choose to play an “environmental” card (a relatively liberal position) or to play an “economic development” or “energy” card (a relatively conservative position). The cards may be permanent (usable multiple times) or consumable (usable only a pre-determined number of times before they run out). A player may alternatively, or in addition, take such positions through selecting multiple choice selections when an issue is posed, and also by voting on legislation in committee and on the floor (e.g., voting on whatever oil drilling bill is produced from the oil drilling issue).

The positions the player takes may be reflected in popularity of the player with constituents (via simulated opinion polls and ultimately at the ballot box), with colleagues (e.g., via showing on a player's screen reactions of other representatives in the committee room when the position is presented, such as by showing them smiling or frowning or showing an icon next to them (e.g., a green or red light) that represents their reaction as being positive or negative), or in popularity with supporters (e.g., via increased monetary donations).

As noted above, a player may act in a world populated by automated avatars that reflect their real-life political alter egos, and/or may interact with other players, such as their personal friends in their own world or in another player's world. For example, a player may serve with a real-world friend on a committee, and each may be presented as being a representative from the particular state to which they have assigned themselves. In other situations, however, a player may take on a different role when entering another player's world. For example, a player may serve as a helper or staffer for another player or make take on other roles other than their role as a political representative, such as to take a break from having a high-profile virtual role, or to accrue in-game points that can be used for various purposes. As another example, a player may help a friend's political campaign and may, from that, obtain popularity points among his or her own constituents, or may obtain money to be spent in his or her own campaign.

Players may also progress in a game and take on additional roles. For example, a player who is successful as a U.S. representative and obtains cash and popularity, may choose to run for Senate, and eventually for President. A game may support multiple such presidents, as each player may simply run for office against a game-created fictional opponent (though in certain situations, two or more players can campaign against each other). Players may also enter sub-games that affect their character or office in the main game. For example, a player may move to a fishing or hunting game and bag a trophy that the player may then have mounted on the wall of his or her Congressional office. That item may then affect players in the main game, such as by pleasing hunters who visit the office (resulting in increased donations) or offending environmentalists who visit the office (resulting in negative press or lower scores with the public).

Additional features may also be provided as part of a broader game like that discussed above. For example, when players check in to the game for each session (preferably a daily or more than once-per-day session), they may be presented with news and a poll. The poll may be taken of them as an actual person, rather than of their avatar, and may request their view on a particular current topic of interest. The poll may be commissioned, for example, by a company or politician or party seeking to canvas the public's viewpoint on an issue. A player may be rewarded with in-game points or other awards for answering such poll questions. Also, reports from polls may be processed by an operator of a game system so that the results better reflect what the poll requester is seeking. For example, players may have previously identified their position on a range from conservative to liberal, and the poll results may be presented to reflect such prior positions (though in an aggregated manner than preserves the anonymity of each player)—e.g., by showing that strong liberals prefer a proposal X % to Y %, that moderate liberals prefer it X % to Y %, etc.

As another log in feature, a player may be presented each day with a hybrid newspaper—containing stories from the real-world (e.g., obtained from the Associated Press or from publishing partners of the operator of the game) and from the game world (e.g., provided by players who want to act as reporters in the game, or provided by the operators of the game world). The respective stories may have their backgrounds colored differently based on their source, or may be otherwise marked so that players can readily determine what is real in the news and what is virtual. In this manner, a player of the game can keep up with the real world headlines and news stories while also taking part in the game, and will thus be more likely to consider the game experience to be productive rather than wasteful, and to make it part of the player's regular daily routine.

In one implementation, a computer-implemented electronic gaming method for electronic polling is disclosed. The method comprises receiving a third-party request to provide a polling question, for a fee, to members of an electronic on-line gaming community; submitting the polling question to a plurality of members of the on-line gaming community and obtaining responses from at least some of the plurality of members; identifying demographic information for the plurality of members in order to select the plurality of members to be subjected to the polling question, to characterize responses from the plurality of members, or both; and providing, to the third-party that requested provision of the polling question, statistical information about the obtained responses, the statistical information not identifying any personally identifiable information about particular ones of the members. The polling question can concerns a political issue of current public concern, or a political candidate. The method can also include awarding in-game credit to members who give responses to the polling question, and adjusting the statistical information before providing the statistical information to the third-party, to remove sampling bias caused by differences between the plurality of members and a target demographic identified by the third-party.

In another example, a computer-implemented electronic gaming method for electronic polling is disclosed that comprises establishing an immersive on-line gaming system; enrolling a plurality of users with the on-line gaming system and assigning in-game characters to the plurality of users; obtaining polling responses provided by the plurality of users to the polling system, and generating statistics regarding the responses without affecting characteristics of the in-game characters as a result of the responses; and receiving inputs that direct actions of the characters from the plurality of users and affecting profiles that describes the in-game characters as a result of receiving the inputs that direct actions of the in-game characters. The inputs that direct actions of the characters can comprise receiving votes on in-game political issues by in-game characters who have in-game roles as politicians. The method can also include providing, to one or more third-parties, statistics regarding the polling responses. The statistics can be provided in response to the one or more third-parties identifying a polling question to be posed to users of the system. The method can also include awarding in-game credit to members who give responses to the polling question. Moreover, the method can comprise statistically adjusting the statistical information before providing the statistical information to the third-party, to remove sampling bias caused by differences between the plurality of members and a target demographic identified by the third-party.

In yet another implementation, a computer-implemented electronic gaming method for electronic polling is disclosed that comprises establishing an immersive on-line gaming system; identifying avatars for in-game characters who correspond to real-life public figures; allowing the real-life public figures to change a first subset of features of their corresponding in-game avatars; and preventing the real-life public figures from changing a second subset of features of their corresponding in-game avatars, the second subset of features representing past actions by the real-life public figures. The second subset of features can represent past voting patterns by real-life public figures who are politicians, and the first subset of features can represent positions of the real-life public figures on current or future political issues. The immersive on-line gaming system may permit players to take in-game roles as politicians who vote on legislation and take positions on public topics. Also, the method can include positively identifying the identity of a real-world public figure before giving the real-world public figure authority to changes the first subset of features of their corresponding in-game character. Moreover, the method can comprise receiving real-time news feeds regarding public activity by the real-life public figures and updating in-game information for characters corresponding to the real-life public figures to reflect, in a game, the public activity.

In yet another implementation, a computer-implemented electronic gaming method for administering user interaction with gaming elements is disclosed, and comprises establishing an immersive on-line gaming system, providing a character of a player with a plurality of cards, each card being associated with a position for the player to take on a political issue, presenting the player with a political issue, receiving an indication of one of the plurality of cards selected to be played by the player in relation to the political issue, and affecting a score for the player in the on-line gaming system based on which card the player selected to be played. The player can hold a plurality of cards that are responsive to the issue, and wherein the player selects one of the plurality of cards.

The details of one or more embodiments are set forth in the accompanying drawings and the description below. Other features and advantages will be apparent from the description and drawings, and from the claims.

### DESCRIPTION OF DRAWINGS

FIG. 1A is a conceptual diagram of an environment for players of a political MMORPG.

FIG. 1B is a bubble diagram of activities for a player in a political MMORPG.

FIG. 1C is a block diagram showing features of a political MMORPG.

FIG. 1D show different screens that may be displayed to a player in a political MMORPG.

FIG. 2 is a block diagram of a system for providing MMORPG activities to players.

FIG. 3A is a flow chart of a process for adjusting polling responses from MMORPG gamers for statistical accuracy.

FIG. 3B is a flow chart of a process for real-world polling in an immersive gaming environment.

FIG. 3C is a flow chart of a process for maintaining user-controlled and uncontrolled aspects of an in-game avatar.

FIG. 4A is a flow chart of a process for maintaining avatar roles in different sub-games of an MMORPG.

FIG. 4B is a flow chart of a process for managing player interaction in a political MMORPG game.

FIG. 4C is a flow chart of a process for statistically modeling behavior of real-world politicians for predicting action in an MMORPG game.

FIG. 4D is a flow chart of a process for transferring earned items between different sub-games of an MMORPG.

FIG. 5A is a flow chart of a process for coordinating news from inside and outside an immersive video game.

FIG. 5B is a flow chart of a process for coordinating campaign funding to multiple political candidates.

FIGS. 6A-6H are screen shots of an MMOPRG political game.

FIG. 7 shows an example of a computer device and a mobile computer device that can be used to implement the techniques described here.

Like reference symbols in the various drawings indicate like elements.

### DETAILED DESCRIPTION

This document describes systems and techniques for administering a political game that can be played by players distributed across an entire country and the world. In general, each player takes the role of a politician (through an avatar), both as an active politician and as a candidate in a next following election. Each new player enters the game as a newly-elected U.S. Representative from a district in a state that the player identifies (typically, the player's home state). The player is provided with an office and office staff, and takes on the day-to-day tasks of a politician. For example, the player may meet with lobbyists and constituents in her Congressional office, may attend committee meetings, may attend speeches or votes on the floor, and may make public appearances, such as on news radio or television programs, or by giving publicly repeated speeches.

Each player (as their avatar) may separately undertake campaigning activities, such as by mailing out campaign literature, attending fundraisers, working with constituents who may also be donors, and the like. In addition, each player may take actions in other sub-games that are not directly related to their role as politicians, such as by playing a fishing game or other such game. Fish caught in the fishing game may be transferred to the political sub-game, such as for mounting and hanging on the wall of the representative's political office.

The various actions taken by a player may cause their fundraising to increase or decrease, and may also cause their popularity to increase or decrease—both affecting their ability to progress in the game (by funding advertising for re-election and in obtaining votes for re-election, and perhaps subsequent runs for higher office such as Senate or President). For example, a player may take a position on a particular issue that may be popular with certain special interest groups (which will result in more donations for a campaign), but not popular with their constituents (which will lower approval ratings until the player can spend the extra raised money on campaigning to increase their ratings with voters). In certain examples, players may be provided with a number of position “cards” that they can “play” at appropriate times. Each of these cards may state a type of position on an issue—for example, a “freedom” card may be played when a player does not think the government should interfere with some group—e.g., a Democrat-minded player might play the “freedom” card during a debate over a social issue, while a Republican-minded player might play it during a debate over business regulation. Some cards may be “durable” in that they can be played an unlimited number of times, while others may be “consumable” in that they can be played only once (or a certain n integer number of times) and the player loses them. Players can also earn certain cards. For example, a player may be provided initially only with cards that stake out fairly hard-line positions on issues, whereas over time, they may earn cards that stake out more nuanced, moderate positions, so that experience with the game increases the player's flexibility with, and success in, the game.

The characters in a game can include real-world politicians in addition to players of the game (whose avatars would appear as politicians or other characters). In particular, Congressional and other political positions can be filled with avatars for the people who actually hold the positions—and those real-world politicians or their delegates may control certain aspects of such avatars. Thus, for example, a particular player will see themselves as the 101st Senator or the 436th Representative, and see avatars in their game for the real-world politicians. Those avatars will act according to data that is collected for their real-world actors, and particularly, their avatars will reflect political positions consistent with positions the real-world politicians have taken in the past, whether by their voting or through publicly-stated positions on various topics. The characteristics of a real-world politician's avatar can include both aspects the politician can control (when logged onto the system with appropriate credentials) and aspects they cannot control. For example, a real-world politician can identify his or her current position on particular political topics that a system might identify (e.g., “for” or “against” a particular position), but can be prevented from changing information that reflects actual past activity by the politician, such as votes by and news articles about the politician.

Players can also advance in the game to different political positions. For example, a player who is successful as a Representative, and sees his or her poll numbers, name recognition, and fundraising grow, can run in a next election to be a third Senator from the state in which he or she is a Representative, or alternatively can knock off one of the existing Senators in a head-to-head election battle (though the existing Senator may remain a Senator in the game even after the election, so as to maintain continuity in the game with real-world events). Also, a player may run for President, and multiple players may be President at the same time, though they will be the only President in their particular instantiations of the game.

In certain instances, and in certain manners, players may “visit” the games of other players, such as particular ones of their friends. For example, one player may campaign on behalf of another player, such that in theory, there would then be 437 Representatives in that particular game (though perhaps in such a situation, the work by the player in the game would not involve voting, but only offering statements or other help in a campaign). A player may gain points for such campaigning, such as points that will assist the “helping” player if they later decide to run for President (e.g., a “national recognition” score for the helping player may rise to a level that makes a Presidential run realistic).

In some implementations, a player can give up points by helping another player, but may gain those points back plus interest later in their game. For example, a player may not have an upcoming election and thus may be able to put some effort forward to another player to help that player win an upcoming election. That may cost the first player points (because they ostensibly have not spent enough of their recent efforts on their own constituents). But if the other player stays in the game and wins, the first player may get those points back and more a year or so later in the progress of the game when they are up for election.

With respect to this example, it is worth noting that certain “storylines” in the game may be tied to real-world time, and others may run on a separate schedule. For example, a player would not have to play the game for 2 years (or 6 years as a Senator) before facing reelection—such elections could occur every month or two. However, the flow of certain issues into the game from the real world (e.g., a player taking a position on a certain actual presidential campaign, and deciding to support or not support a candidate in such a campaign) may necessarily have to match real-world time. The time flow for such particular story lines may vary based on the type of activity trying to be exhibited in the game, and on the particular implementations.

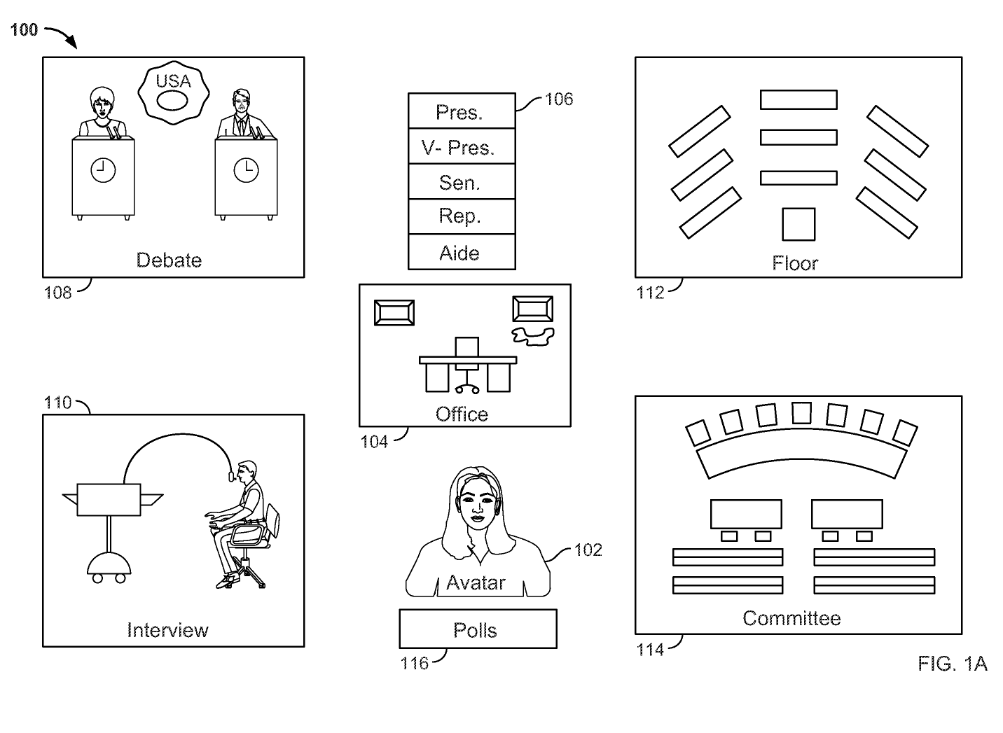

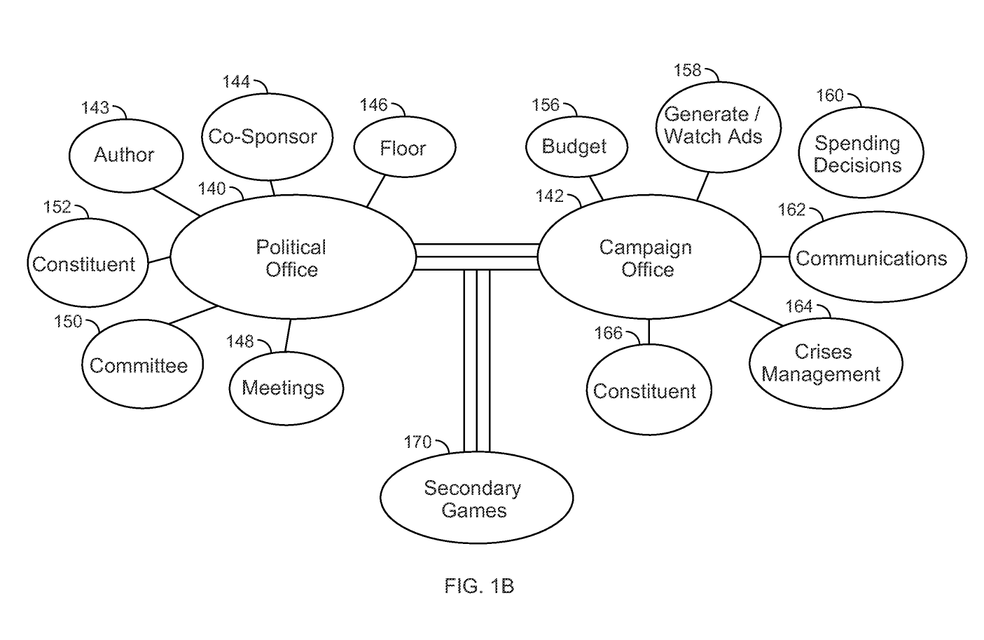

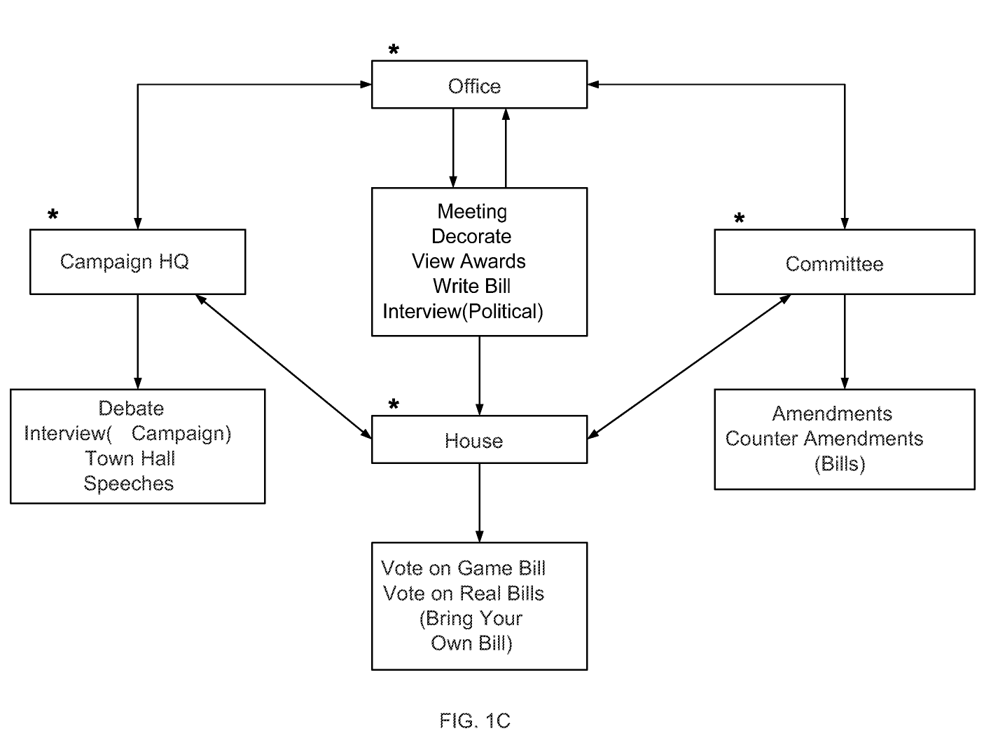

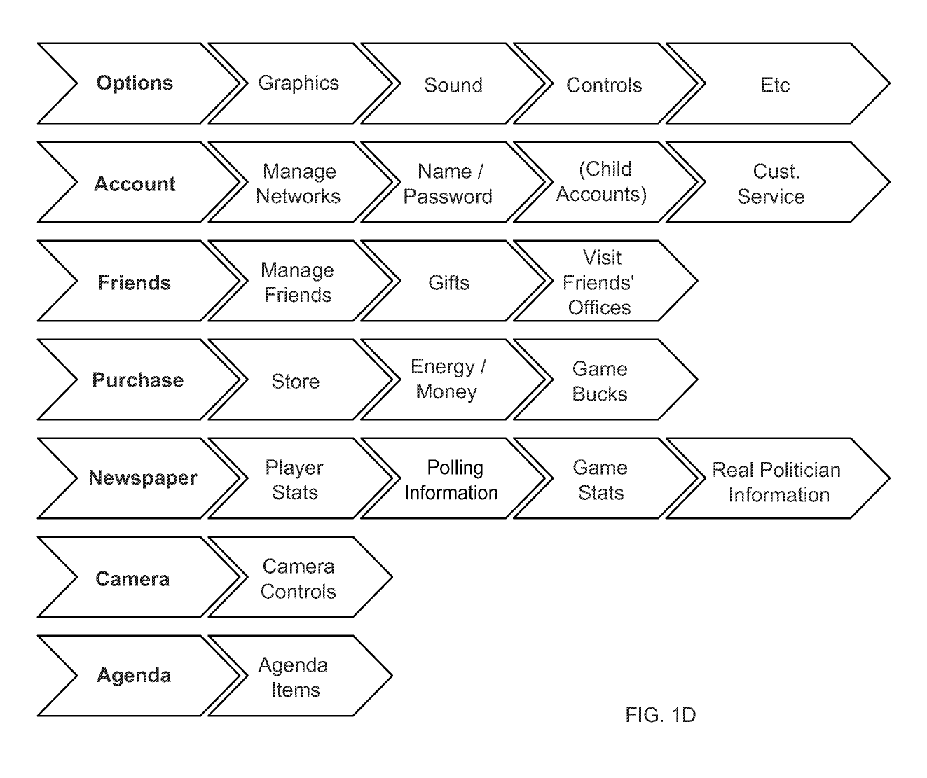

FIG. 1A is a conceptual diagram of an environment 100 for players of a political MMORPG. In general, the environment 100 includes a number of scenarios in which a player in an MMPORG game may find themselves. The player's avatar 102 is represented in the environment 100 and may act like avatars in other MMPORG games. For example, a player may select a “look” for the avatar, such as by selecting a hairstyle, clothing, and other similar features. The avatar may be displayed to the player as they play the game, and to other players that enter the first player's world, in a normal and known manner.

An office 104 serves as a base of operations for a player, and is the location at which a player's avatar 102 may start each round of the game (e.g., each day that the player begins playing). The office may be displayed graphically to the player, may be decorated by the player to personalize the office, and may be visited by other players or by computer-controlled characters such as lobbyists and constituents of the player's avatar. The decor of the office may have an effect on visitors, such as by the display of certain items in the office causing visitors to have a positive or negative view of the player's character (e.g., display of an NRA certificate pleasing some and angering others).

A role 106 for the player represents the political role that the player is currently holding in their game. For example, the player may be a U.S. Representative or other politician (e.g., a city council member trying to work his or her way up through a party mechanism). A player may have multiple simultaneous roles, such as a role (e.g., politician) in his or her own game, and a different role in the game of a friend (e.g., staff member of a politician). The player's avatar and name may be the same between the two roles, but other characteristics, such as the things the player can do and the decisions the player is asked to make, may vary based on the current role. A player may gain points or other game currency in their main game by performing actions in the games of other players, such as their friends.

In a debate scenario 108, a player may be presented with various issues and may provide answers to those issues, such as by playing a position “card” that the player currently holds, or by selecting an answer from a multiple choice question posed on an issue in the debate. A debate may involve multiple such questions and answers, and may affect the public's perception of the player's character in the game. The opponent in a debate may be computer-controlled or may be controlled by another player in the game. When the player takes part in a debate, a user interface may show her and her opponent, and questions may be posed on-screen or audibly. The player may then be given a certain fixed amount of time to select a response to each question. Reactions to the answers may be displayed in real time, such as by showing expressions on the faces of attendees of the debate or showing a graph, such as a hot/cold meter that moves toward hot when the player provides good responses and toward cold when the user provides bad response (as determined by the game system).

An interview scenario 110 is similar to a debate scenario 108, but is more one-sided. Again, a player may be posed questions and may answer the questions in various ways, such as by answering a multiple-choice question, by playing a particular political issue card, by filling in a blank with an answer, or the like. The audience for the interview may be made known to the player before the interview, so that the player may mold his or her questions for the audience—for example, a TV audience may be more broad-based, while a talk radio audience may have more focused views that are more in tune with the player's actual views, and the player may obtain better response from the latter audience by providing more polar (politically) answers.

A floor scenario 112 displays the full chamber of a legislature, and a player may be presented with issues (e.g., bills) on which the player is called to vote yes or no. The player's votes may be tallied and her score on different parameters, such as the happiness of her contributors and the happiness of her constituents with her performance may change.

Such scoring may be achieved by assigning each position on an issue a score along a range on various parameters, and then comparing the player's vote either for or against those parameters with the desires of the constituents or other stakeholders, with respect to the same parameters. The other scoring for a player described herein may use similar techniques (e.g., a stated position as provided in a card that a player plays may be treated similarly to a vote in favor of or against a particular bill).

A committee scenario 114 is similar to a floor scenario 112 and a debate scenario 108, in that a player can both make statements during committee debate (and have their score affected accordingly) and may vote on issues that come before the committee (and have their scores affected accordingly). A player may generally only serve on a limited number of committees, and their position on a committee may vary based on their seniority in a particular legislature, just as in real politics.

Each of the scenarios shown here may, then, represent a sub-world in which the player may operate at different times while playing an MMPORG that is politically-centered. They may voluntarily enter each sub-world in real-time, or may establish a schedule in advance and then have a virtual aide tell them that it is time to move to one of the sub-worlds (where the game time does not have to match real-world time, so that a player can play the game whenever she is free). For example, a player's schedule may be pre-populated with committee and floor events, but the player may choose to intersperse that fixed scheduled with other events such as interviews and campaigning-related events. Other sub-worlds may also be provided in such a game, and may be added to an on-line game over time as the game matures. For example, a game may be launched initially only with the “working” sub-worlds shown here, but may be supplemented later with “campaigning” sub-worlds as those are developed—e.g., parades, press conferences, campaign budgeting exercises, sending of fundraising communications (which may include a player selecting from multiple example communications and fundraising targets, and the game reflecting funds in the campaign account consistent with how intelligent the game judges the player's selections to have been).

FIG. 1B is a bubble diagram of activities for a player in a political MMORPG. In general, the diagram shows relationships between various components and subcomponents that may be provided in such a game. Certain of the components correspond to components discussed with respect to FIG. 1A above.

The components are generally split between a “political” office 140 for a player's character and a “campaign” office 142. The political office 140 represents the service side of the character's life, and relates to legislating, constituent service, and other types of activities that a normal politician would perform as part of his or her job. The campaign office 142 represents the election side of the character's life, and relates to fundraising, campaigning, and similar activities aimed at furthering the character's candidacy and campaigns. Certain of the aspects discussed here may overlap between the two aspects of a character's existence, but they are shown in particular areas here for purposes of explanation.

Referring now to aspects of the political office 140, an author aspect 143 represents activities that a player (via their avatar) may undertake in authoring or co-authoring new legislation. The player may author legislation by selecting pre-existing components provided by a game system relating to an issue. For example, the game system may define an issue (e.g., a certain type of carbon offset legislation), and may define a number of parameters for the legislation—e.g., who will be subject to regulation, what are the penalties for non-compliance, who will be responsible for implementing the legislation, etc. A player may a selection for each such parameter so as to craft a piece of legislation that makes a mix of policy choices. The player may then submit the legislation as a bill for processing in a normal fashion through the Congress. (The submitted legislation in such an example might not be actual text of a bill, but instead particular choices of values for discrete sub-issues relating to the topic, like those just discussed.)

Similarly, a player may review legislation that has been prepared in a similar manner by other players (whether actual players or computer-controlled characters) and may sign on as a co-author or co-sponsor of the legislation (aspect 144). The player may then gain game currency if the legislation is successful, since the player's name will be closely associated with the legislation (though the player could lose credit if the legislation they select is bad for their constituency—e.g., a player who represents Wyoming drafting successful legislation that shifts money to urban areas).

The floor aspect 146 relates to the floor scenario 112 of FIG. 1A. When a player chooses to go to the floor, their user interface may change to display the Congressional chamber, and the options available to the player may change accordingly. For example, the player's options may be limited to giving a speech (e.g., filibustering by typing for a long time, or cut-and-pasting entries from the telephone book) or voting on pending legislation.

A constituent aspect 152 represents actions that a player may take to meet with or otherwise perform functions on behalf of his or her constituents. For example, constituents may appear in a player's avatar's office, and the player may be prompted to select example dialogue with which to interact with the constituents. As one example, a player may earn extra points for interspersing a conversation with folksy points about their district (e.g., selecting a statement about “going up to the lake” if their district is in Minnesota). Similarly, the player may perform actions such as recommending a constituent for the West Point academy, assisting traveling constituents with passport problems, and the like. Such tasks may allow the player to accrue points in the game (e.g., where the points might lead directly to greater approval rating and more votes, or may be spent like money on things like campaign advertising).

A meetings aspect 148 represents communications a player may have with entities other than constituents, such as lobbyists. Again, the meetings may be presented as conversations, where the computer-generated character makes a statement, and the player is allowed to select verbal responses from a list of suggested responses or to play a particular political position card from a plurality of candidate cards. As one example, a business lobbyist may ask if the player intends to support a particular piece of legislation, and the player can select a yes, no, or middle-ground response, while understanding possible effects that such responses may have on their popularity scores and/or campaign finances. Certain responses may be unethical or illegal, and selecting such responses may cause the game to follow up with ethics or criminal proceedings against the player's character.

With respect to the political office 142, a budget aspect 156 requires a player to view his or her campaign budget and to allocate spending and fundraising resources in various manners. For example, a player may be shown a cash flow sheet, and may change values in different categories on the sheet to fit his or her needs. For example, the sheet may include entries for direct mailings, radio ads, television ads, and the like. It may also include entries for particular types of fundraisers that a player may want to schedule, and can include messages relating to fundraising, such as by showing a player who has just supported anti-piracy legislation that they have received a campaign contribution from the recording industry, or similar such entries.

A generate/watch ads aspect 158 provides an interface by which a player may formulate advertising for a campaign. For example, a list of selections for “message” and “sub-messages” may be displayed, and a player may select them to form an ad to be player in support of his or her campaign. For example, as an initial selection, the player may identify whether the ad is a positive ad for the player's avatar, or a negative ad against the avatar's adversary. The player may then select whether the ad (if the first type) shows them with a family, talks about their record, shows them as a fighter for constituents, or the like. The player's score or popularity level may then be adjusted by the system by a degree to which the player's selected ad parameters match the current interests of the player's constituents—e.g., an attack ad could boost or lower popularity, depending on the mood of the electorate in the player's district.

Spending decisions aspect 160 relates to budget aspect 156, and provides yet another mechanism, which may be like that described above, by which a player can identify how much of their cash in a particular period (e.g., a month or quarter) to spend on each of different categories, such as on political advisers, campaign office staff, campaign amenities (e.g., food for volunteers), transportation, and ads.

A communications aspect 162 represents communications that a player may initiate with constituents. For example, the player may compose campaign mailings for the district and may select from a number of prepared issues to include in the mailings. Again, just as with ads, the mailings may cost money to execute and may raise or lower the approval ratings of the player's character based on whether the topics selected by the player for a mailing resonate with the current views of the electorate.

A crises management aspect 164 may (hopefully) be used infrequently by a player, but may be necessary or helpful when there is trouble. For example, a system operating a game may announce to a player that his or her chief of staff has been arrested for shoplifting. The player then may access a UI for the crises management aspect 164, such as to select from a list of potential strategies for dealing with the crises. Again, the player's selected approach may be reflected in a favorability rating for the character.

Finally, a constituent aspect 166 may be similar to constituent aspect 152, but may present activities and selections for a player with respect to things the player does for constituents in a personal capacity rather than in a government capacity. For example, a candidate may perform favors for constituents—some of which may be unethical or even illegal. In some instances, such improper conduct may help the candidate (e.g., via increased campaign contributions from the assisted constituent) or may catch up with the candidate (e.g., with a need to later use the crises management aspect 164).

Finally, secondary games 170 represent activities into which a player may place their character that do not have anything directly to do with campaigning or working as a legislator. For example, as discussed above, a player may play a fishing game, perhaps as their legislator character, as a break from the political game, and action from that secondary game may be reflected in the primary game, such as by bringing a trophy fish back to the player's office from the fishing game. In a hosted environment, new secondary games may be introduced from time to time so as to provide new interest to the overall game.

FIG. 1C is a block diagram showing features of a political MMORPG. In general, the components shown here are similar to those discussed for FIGS. 1A and 1B, though shown arranged in different representations. However, the figure generally shows the four main scenarios for a player (office, committee, campaign HQ, and house) and the activities that a player can take for their character in each of the scenarios (other boxes).

FIG. 1D show different screens that may be displayed to a player in a political MMORPG. Each row in the figure indicates, at its left edge, a title of a menu that is accessible at a “root” level of the game, and each of the portions to the right of the leftmost portions represents selections that are available from the particular menu at the root level. For example, a player from a home screen may select a newspaper, and then may be presented with the options of viewing player statistics (e.g., money/points in the player's virtual account, popularity figures for the player, a region that the player represents in the game, etc.), of viewing polling information (e.g., their own answers to past polls, and statistical information about polls they were presented with and/or answered, such as showing their answer and the percentage of people or the percentage in particular demographic groups (age groups, political party or philosophical affiliation, income level, geographic location, etc.) who answered a particular way), seeing statistics about a game they are playing (e.g., percentage of players at various levels such as at particular political offices, and other non-polling data about the game, and obtaining real political information, such as information about real-world political events that are linked to virtual events in the game). With respect to real-world events and virtual events, each such event may be correlated to one or more topical keywords that represent a topic of the event. For example, a virtual bill in the game for limiting assault weapons and a real-world story about a shooting could be associated with the keyword “Gun Control.” A player could then access a newspaper in the game and a page in the newspaper could display both the real-world story about the shooting, but also polling data from players of the game or voting data from players of the game on gun control issues. In addition, a story about the virtual legislation may also be prepared and displayed as if it is a real-world story (though players will know that it is not a real world story either because of a predetermined marking on the story (e.g., stories about the virtual world are always in italics or comic sans font) or because of entities named in the story being virtual entities.

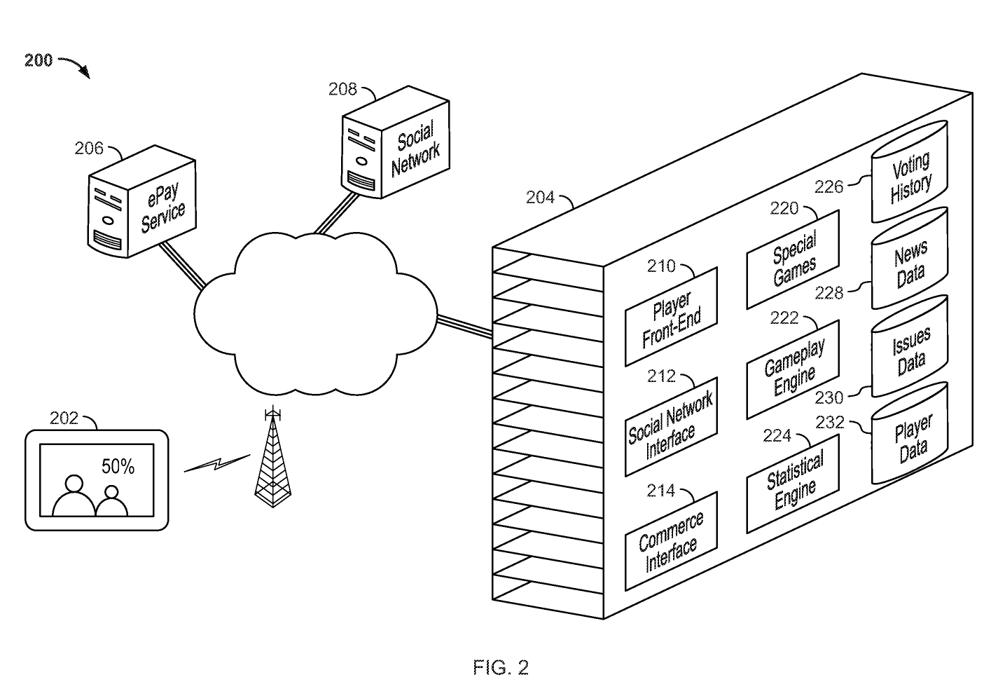

FIG. 2 is a block diagram of a system 200 for providing MMORPG activities to players. In general, the system 200 is shown here as an arrangement of example server systems 204, 206, 208, that may communicate with each other to provide game data and UI components to various users, including a user logged into a game with mobile device 202, such as a tablet computer or smartphone. Such a user may be a registered player of the game who is represented in the game by one or more avatars that take the roles of politicians in the game (as one example).

The main server systems include a game server system 204 that manages most gameplay aspects of a political game, such as the aspects described in the figures above and below. The system 200 also includes a social network server 208, which may manage access to the content from the game server system 204, e.g., in the manner that FACEBOOK permits various games to be accessed by users who visit their FACEBOOK accounts. The social server system 208 may also share certain information with the game server system 204, such as information that identifies friends of a user, so that the political game may allow friend-based interaction in a game. The ePay service 206 may be a service such as PAYPAL that may permit a player to purchase in-game items and/or donate actual money to real politicians who have avatars in the game system 200.

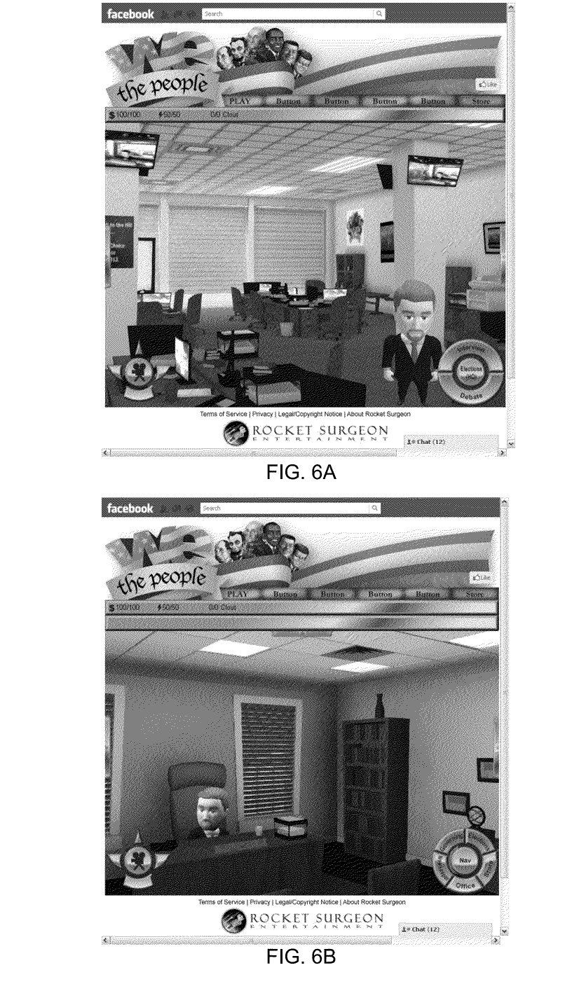

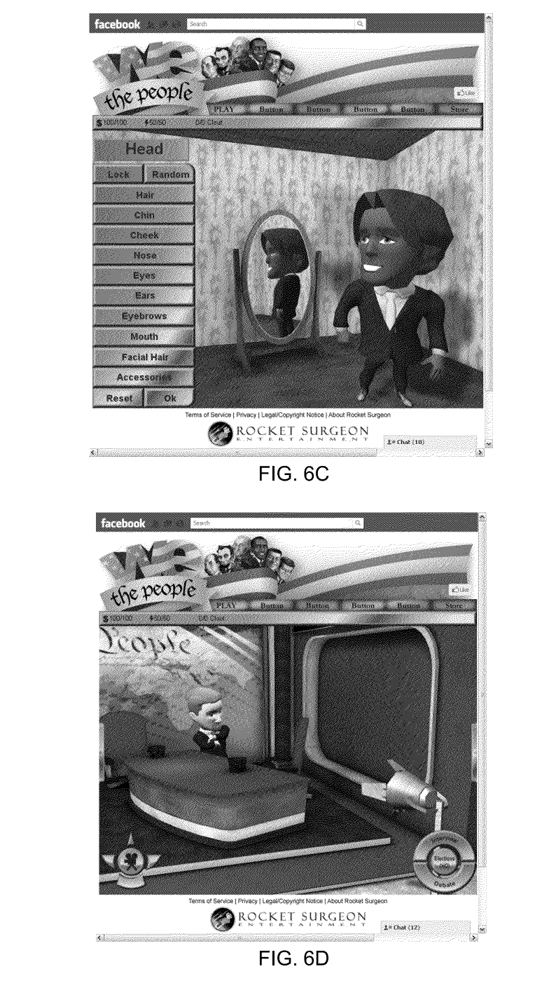

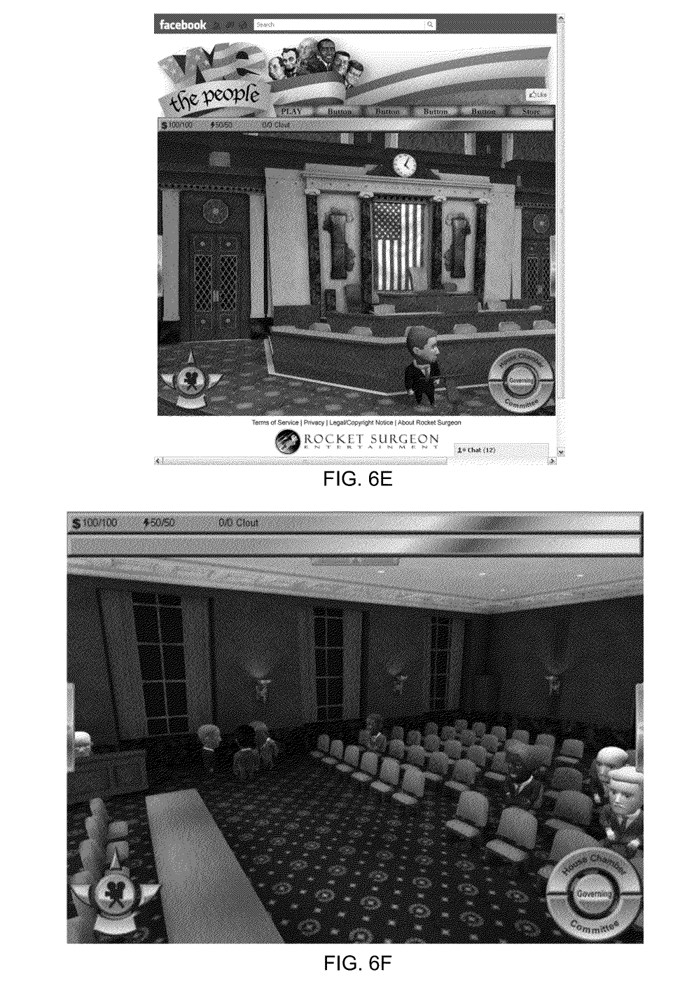

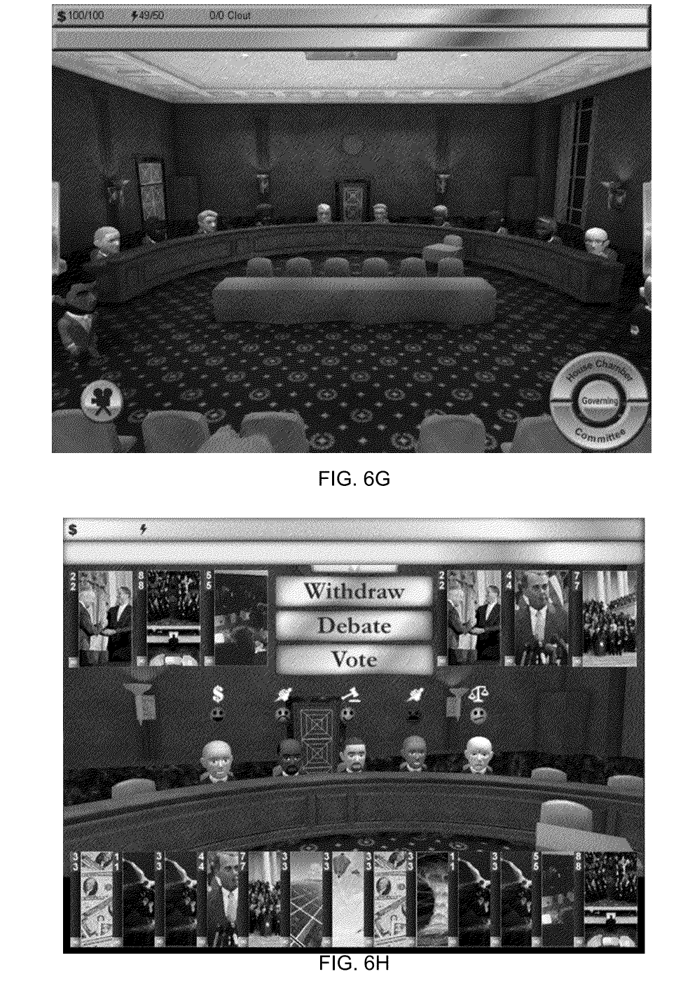

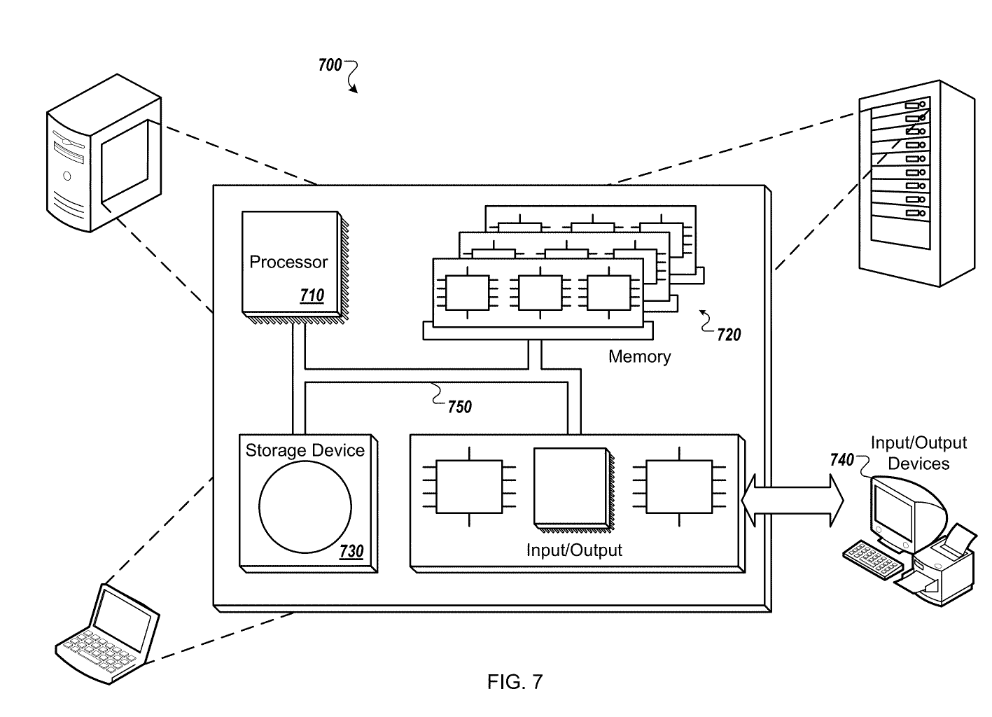

Particular components of the game server system 204 may provide for functionality like that described above and below. For example, a player front end 210 may act as an interface between players of an MMPORG and the various services offered by the server system 204. The player front end, for example, 210 may receive commands from user and may generate code for execution on user computers, such as device 202, to show the effects of such user selections. For example, the front end 210 may generate displays like those shown and discussed below in FIGS. 6A to 6H.

A social network interface 212 may interact with the social network server system 208 so as to permit playing of the game through a social network, and/or with friends defined by the social network. In the former situation, the server system 204 may provide data that may be rendered into a page hosted by the social network, either by directly providing the code to device 202 that may render the code into an element like an iFrame, or by providing the code to the social network server system 208 which may in turn incorporate the code into code for the social network itself. Similarly, a commerce interface 214 may interface with the wPay service, so that, for example, when a player seeks to purchase something in a game, they may do so using a familiar payment mechanism, and the game operate may be paid by the operator of the ePay service 206.

Deeper in the server system 204 is a gameplay engine 222 which may be programmed to manage interactions like those discussed above and below in the game. The engine may, for example, present challenges to players, analyze their responses to those challenges (e.g., by mathematically determining how a vote on an issue that was on the floor should be reflected in the approval rating an donations provided to the player's avatar).

A statistical engine 224 may be referenced by the gameplay engine for a variety of tasks. For example, the statistical engine may generate reports for polls that are taken of players (acting as themselves rather than as their avatars), including by normalizing the poll responses so as to better reflect the views of the general electorate rather than just the views of people who play MMPORG games.

Special games 220 may be relatively large in number, and may represent games that are not integral to the gameplay of the main MMPORG but that may generate and pass data that is used in the main MMPORG. One such example, used above, is a fishing game that make take the form of typical simple fishing games, but when completed, may pass back to the main MMPOORG game information about what fish a player caught, so that, for example, the player may be asked whether they would like to mount the fish on a wall, have a campaign cook out, or the like.

Various data stores 226-232 may be used to store data for, and may be accessed by, the other components just discussed, in allowing those other components to catty out the actions discussed herein. For example, voting history 226 may store data regarding the manner in which real politicians and game playing politicians voted on certain issues. The voting history 226 may also store data that characterizes each such issue, such as by scoring the issue on a two-dimensional scale between liberal and conservative, or by characterizing it in various other manners that can be used to better characterize the political views of those who voted yes or no on the issue.

News data 228 represents real world and game world news for a game. Such data may be used, as discussed above and below, to generate a newspaper or similar news source for players in a game.

Issues data 230 may be data that is used to characterize various political issues that may come up in the life of a politician. For example, as discussed above for the voting history 226, each issue may be scored on one or more parameters that are considered to be relevant to politically characterizing an issue, such as how liberal or conservative each side of an issue is, whether each side of the issue looks to greater or less government involvement, and the like. As such, the issues data 230 may be used to analyze existing or new issues and to score players upon multiple dimensions, since the historical polars on the single liberal-conservative dimension may not adequately characterize issues for rich gameplay.

Finally, player data 232 represents all data that may be used to characterize a particular player (and may be merged with the voting history, at least for players (if not real politicians), in some embodiments). For example, the particular of a player's office, their express political views (which they may enter into a player profile that is stored by the system) and their implicit political positions (which may be inferred by analyzing their voting history against various issued that have been characterized or profiled by the system).

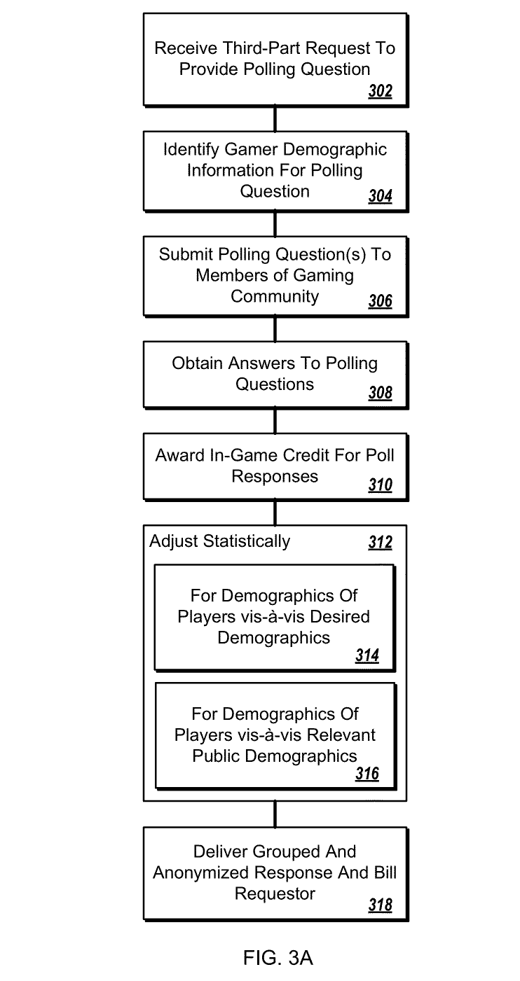

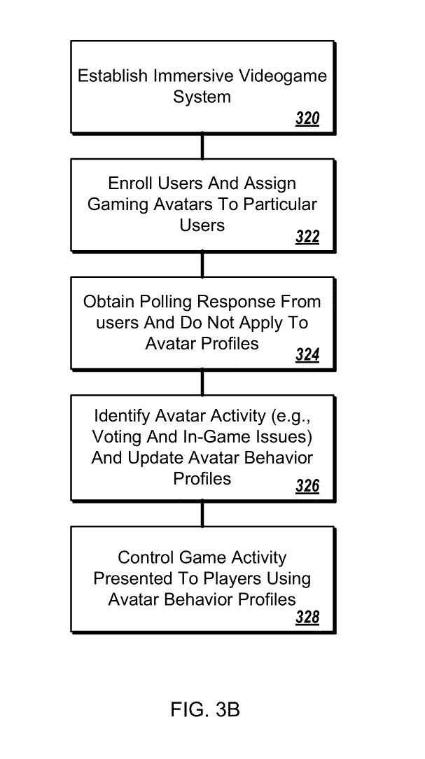

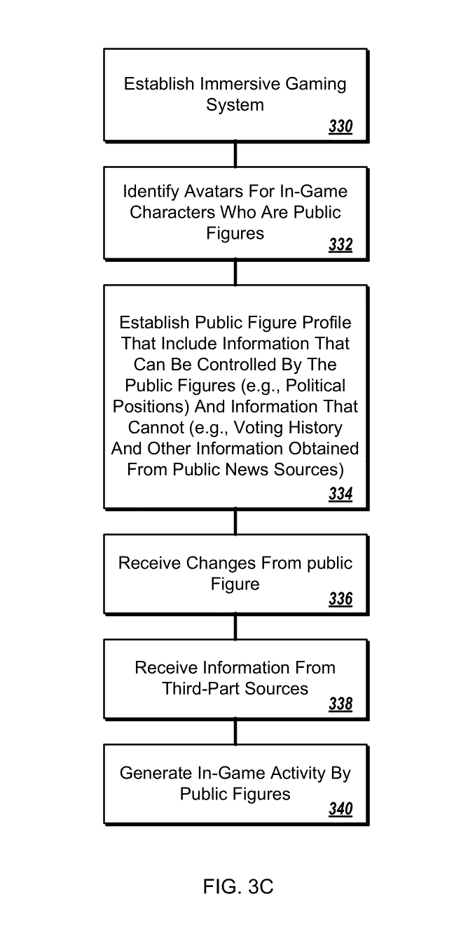

FIG. 3A is a flow chart of a process for adjusting polling responses from MMORPG gamers for statistical accuracy. In general, the process relates to polling related to a political MMOPRG game. For example, authenticated players may be provided a polling question one per day or each time they log into the game, with the question to be answered by the actual players, and not by their respective characters. The system may also limit who receives each polling question based on demographic information that the system knows, such as whether a particular player has self-identified as a Democrat, Republican, or moderate. Players may be rewarded with in-game credit for providing polling answers. Also, answers may be checked to ensure that they are consistent politically with prior responses from a player so as to ensure that the player is reading the polling questions and providing honest answers. Also, to allay third-party concerns that players of the game are not representative of the electorate (whether well-founded or not), the system may make adjustments to aggregated statistics received from the players so as to provide an “offset” to the collected data to make it better align with the general public or the general voting public. For example, an organizer of a poll may indicate, on a scale of 1 to 100, how the polling question relates to a particular technology issue, and the player responses may be adjusted so as to reflect the fact that they are more technology-savvy than an average voter.

At 302, a third-party request to provide a polling question is received (e.g., from a real-life poller or political candidate). At 304, gamer demographic information is identified for the polling question. For example, if the question is believed to break along political lines, the demographic information can relate to which party various players have identified themselves as being part of or where they stand on a political spectrum from conservative to liberal. Similarly, certain polling questions may be best answered with a knowledge of the age, race, gender, or geographic location of the members of the system who answer the poll, or some combination of two or more of such demographic factors

At 306, the polling question or questions (which may have been revised after its initial submission) may be submitted to registered members of the gaming community, such as via a question when they first log into a gaming session. At 308, answers to the polling question are obtained and at 310, in-game credit is awarded to those members who answer the poll (and whose answer is observed by the system as being legitimate—i.e., the answer was not provided so quickly as to indicate the player did not even read the question, the player answered a “control” question provide with the real question in a legitimate manner, etc.).

At 312, various steps may be taken to adjust the responses statistically so that they better match real-world responses. For example, the on-line community might be known to operators of the community, and from other questioning performed on the community, to lean toward tech-savvy and libertarian positions. Polling results may be adjusted back toward center before being provided to a customer so as to correct for such tendencies, where the polling question is deemed to relate to such a bias. Such correction may occur at the individual level, the demographic group level (e.g., answers by male users on topic X are known to be biased relative to males in the general population), or at the community level. Boxes 314 and 316 show that either or both of removing bias both for demographics that the customer is studying and overall public demographics may be performed.

At box 318, the results are delivered and the customer who requested the poll is billed. The results may indicate how results were affected if steps were taking to remove inherent community bias from them. Also, the result may be provided as a simple absolute (e.g., 50% of the members answered “yes” and 50% answered “no”), broken down by demographic group, or in other manners. The results may also be provided dynamically, e.g., by allowing the customer to access on on-line data analysis tool operated by the system so that the customer can see the data from whatever angle he or she desires.

FIG. 3B is a flow chart of a process for real-world polling in an immersive gaming environment. In general, the polling here is performed of players separate from their characters, in one instance, and as part of their players in another instance. For example, when a player first logs in, they may be asked a “real world” polling question, which may have been submitted by a real world political candidate who wants to take the public's temperature on an issue. Later, when the player is “in character”, a vote by the player may reflect the in-game character's preferences, and not be applied by the system to reflect the real-world player's preferences. As such, feedback by a player may be segregated as between what the system knows about the human player, and what the system knows about the player's virtual world character.

FIG. 3C is a flow chart of a process for maintaining user-controlled and uncontrolled aspects of an in-game avatar. In general, the process allows players such as real world politicians to control some aspects of their character or avatar, and not control others. As examples of aspects the particular players cannot affect, the player's appearance may be fixed (if the politician is stout, then their avatar is going to be stout), as may the politician's real-world voting history, and game-derived proclivities of the politician's character on certain issues.

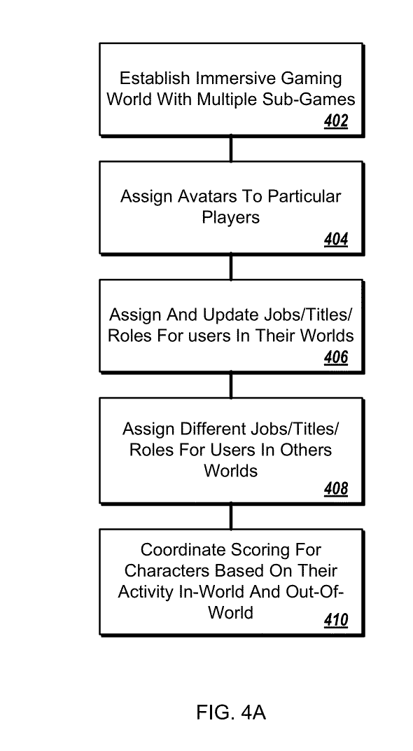

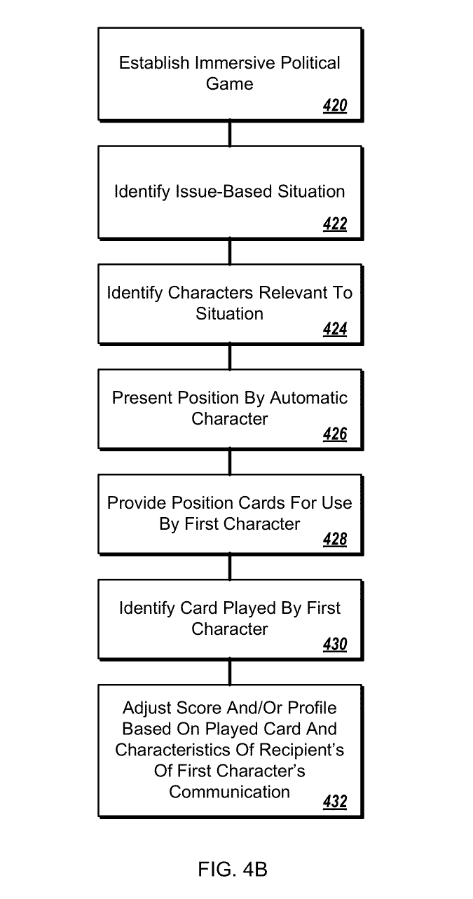

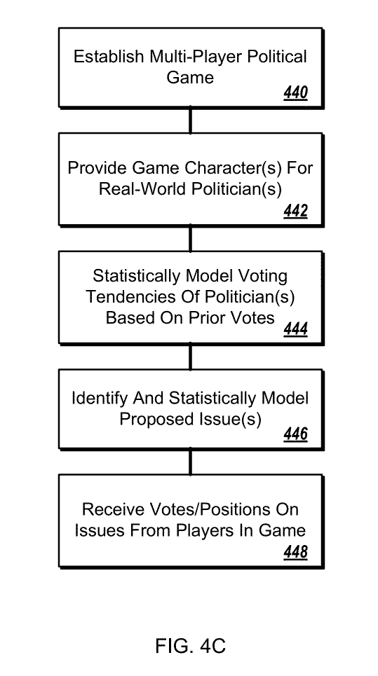

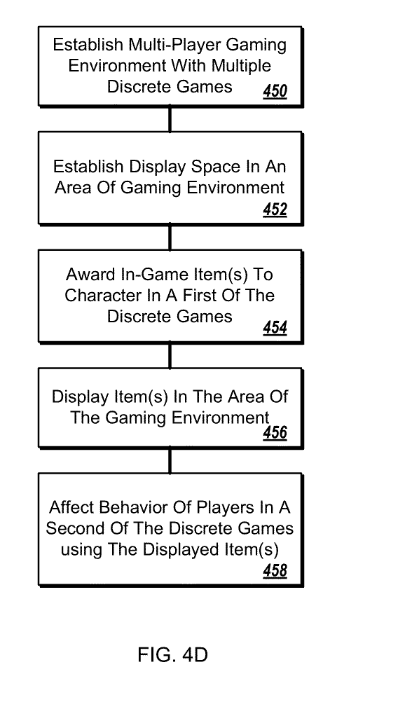

FIG. 4A is a flow chart of a process for maintaining avatar roles in different sub-games of an MMORPG. In general, a player may have a single avatar in a gaming system, where the look and name of the avatar is constant, but the roles or job descriptions of the avatar may vary from game to game. For example, an overall game may instantiate sub-games for each player of the game, so that they each see similar but individually unique worlds—e.g., worlds where they are each respectively a member of Congress. Likewise, the process involves providing different roles to a particular player in a large MMORPG, when the player moves between sub-games in the larger game. In such situations, the character may maintain his or her looks and name, but may be provided a different job title in each of different sub-games. For example, a player may have a “top” role such as a legislator when in his or her own world or sub-game, but may have a “helper” role when visiting a friend's world or sub-game, such as by being a staffer for her real world friend, and helping the real world friend form a campaign strategy (e.g., using things the first player learned from her own earlier campaign).

FIG. 4B is a flow chart of a process for managing player interaction in a political MMORPG game. In general, a player is provided with a number of predetermined “position” cards that each represent a position of the player on a political issue. The player may then take a position when an issue is presented, by “playing” a particular card that the player possesses. Playing of some cards may make them disappear form the player's character's possession, while other cards may be played more than once (either N numbers of times of an infinite number of times).

FIG. 4C is a flow chart of a process for statistically modeling behavior of real-world politicians for predicting action in an MMORPG game. In general, the method involves analyzing a politician's prior voting and public statements to place the politician along a number of political parameters with particular values that statistically represent the prior politician behavior. The process then involves identifying an issue in a game, where the issue is assigned values along ranges for similar parameters. A comparison of the values for the politicians with values for the hypothetical issue may then be used by the system to predict how the politician would vote on the issue. Such voting may also be aggregated so that, for example, a player in a game may select values for political issues (e.g., user a slider-based UI) and then see how Congress would hypothetically vote on the hypothetical issue.

FIG. 4D is a flow chart of a process for transferring earned items between different sub-games of an MMORPG. In general, such a process allows players in a MMORPG that has multiple sub-games to carry items from one sub-game to another, such as in manner discussed above.

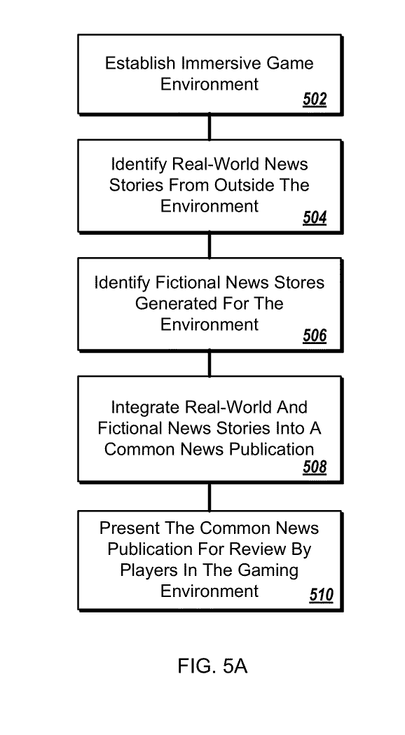

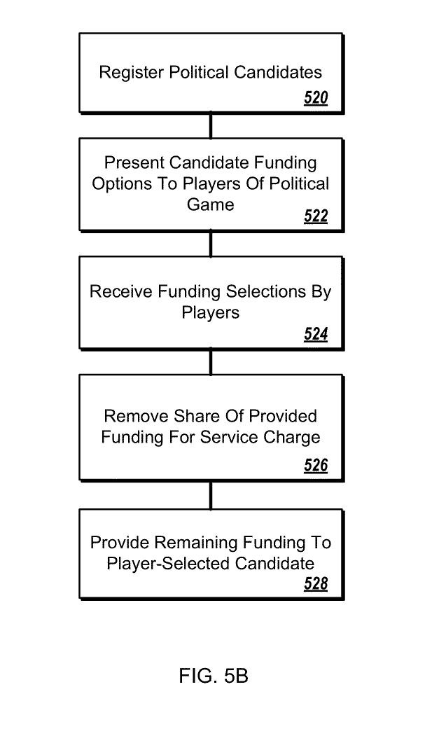

FIG. 5A is a flow chart of a process for coordinating news from inside and outside an immersive video game. In general, the process involves preparing a newspaper, flyer, news magazine, or similar item with headlines and stories both from current event real-world stories and with stories made up from within a game. In such a manner, the method may blending virtual news with real news for a player in a game.

FIG. 5B is a flow chart of a process for coordinating campaign funding to multiple political candidates. In general, the process may allow a player in a game to identify a real-world politician to donate money to, from a group of multiple real-world politicians from two, three, or more different political parties. The system may automatically cause an epay system such as PAYPAL to make the payment, and may automatically generate necessary reporting needed to comply with law, such as a report to election tracking authorities as soon as the payment has been made.

FIGS. 6A-6H are screen shots of an MMOPRG political game. In general, the screen shots show Uls that may be displayed to a player in, for example, the different scenarios discussed with respect to FIGS. 1A to 1C.

FIG. 7 is a schematic diagram of a computer system 700. The system 700 can be used for the operations described in association with any of the computer-implement methods described previously, according to one implementation. The system 700 is intended to include various forms of digital computers, such as laptops, desktops, workstations, personal digital assistants, servers, blade servers, mainframes, and other appropriate computers. The system 600 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. The processor may be designed using any of a number of architectures. For example, the processor 710 may be a CISC (Complex Instruction Set Computers) processor, a RISC (Reduced Instruction Set Computer) processor, or a MISC (Minimal Instruction Set Computer) processor.

In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

What is claimed is:

1. A computer-implemented electronic gaming method for electronic polling, the method comprising:
receiving a third-party request to provide a polling question, for a fee, to members of an electronic on-line gaming community;
submitting the polling question to a plurality of members of the on-line gaming community and obtaining responses from at least some of the plurality of members;
identifying demographic information for the plurality of members in order to select the plurality of members to be subjected to the polling question, to characterize responses from the plurality of members, or both; and
providing, to the third-party that requested provision of the polling question, statistical information about the obtained responses, the statistical information not identifying any personally identifiable information about particular ones of the members.

2. The computer-implemented method of claim 1, wherein the polling question concerns a political issue of current public concern.

3. The computer-implemented method of claim 1, wherein the polling question concerns a political candidate.

4. The computer-implemented method of claim 1, further comprising awarding in-game credit to members who give responses to the polling question.

5. The method of claim 1, further comprising statistically adjusting the statistical information before providing the statistical information to the third-party, to remove sampling bias caused by differences between the plurality of members and a target demographic identified by the third-party.

6. A computer-implemented electronic gaming method for electronic polling, the method comprising:
establishing an immersive on-line gaming system;
enrolling a plurality of users with the on-line gaming system and assigning in-game characters to the plurality of users;
obtaining polling responses provided by the plurality of users to the polling system, and generating statistics regarding the responses without affecting characteristics of the in-game characters as a result of the responses; and
receiving inputs that direct actions of the characters from the plurality of users and affecting profiles that describes the in-game characters as a result of receiving the inputs that direct actions of the in-game characters.

7. The computer-implemented method of claim 6, wherein the inputs that direct actions of the characters comprise receiving votes on in-game political issues by in-game characters who have in-game roles as politicians.

8. The computer-implemented method of claim 6, further comprising providing, to one or more third-parties, statistics regarding the polling responses.

9. The computer-implemented method of claim 8, wherein the statistics are provided in response to the one or more third-parties identifying a polling question to be posed to users of the system.

10. The computer-implemented method of claim 6, further comprising awarding in-game credit to members who give responses to the polling question.

11. The computer-implemented method of claim 6, further comprising statistically adjusting the statistical information before providing the statistical information to the third-party, to remove sampling bias caused by differences between the plurality of members and a target demographic identified by the third-party.

12. A computer-implemented electronic gaming method for electronic polling, the method comprising:
establishing an immersive on-line gaming system;
identifying avatars for in-game characters who correspond to real-life public figures;
allowing the real-life public figures to change a first subset of features of their corresponding in-game avatars; and
preventing the real-life public figures from changing a second subset of features of their corresponding in-game avatars, the second subset of features representing past actions by the real-life public figures.

13. The computer-implemented method of claim 12, wherein
the second subset of features represent past voting patterns by real-life public figures who are politicians, and
the first subset of features represent positions of the real-life public figures on current or future political issues.

14. The computer-implemented method of claim 12, wherein the immersive on-line gaming system permits players to take in-game roles as politicians who vote on legislation and take positions on public topics.

15. The computer-implemented method of claim 12, further comprising positively identifying the identity of a real-world public figure before giving the real-world public figure authority to changes the first subset of features of their corresponding in-game character.

16. The computer-implemented method of claim 12, further comprising receiving real-time news feeds regarding public activity by the real-life public figures and updating in-game information for characters corresponding to the real-life public figures to reflect, in a game, the public activity.
